(19) United States
(12) Patent Application Publication
(10) Pub. No.: US 2007/0009865 A1
(43) Pub. Date: Jan. 11, 2007

(54) Method, system, program and data set which are intended to facilitate language learning thorugh learning and comprehension of phonetics and phonology

(76) Inventor: Angel Palacios, Madrid (ES)

Correspondence Address: Angel Palacios, Mendez Alvaro 77, portal 4, piso 4B, Madrid, 28045, ES

(21) Appl. No.: 10/596,990

(22) PCT Filed: Jan. 7, 2005
(86) PCT No.: PCT/ES05/00007

§ 371 Date: Jul. 4, 2006

(30) Foreign Application Priority Data
Jan. 8, 2004 (ES) P200400031

(51) Int. Cl. G09B 1/00; G09B 19/00

(52) U.S. Cl. 434/167; 434/169; 434/156

(57) ABSTRACT

The invention is intended to facilitate language learning by facilitating the learning of phonology and phonetics in general and, in particular, prosody. For said purpose, the pupil is trained to better perceive the rhythm and metric structure of the target language. The aforementioned training consists in listening to determined auditory playbacks using facilitating means which enable the pupil to better identify the prosodic features of the target language, and to develop his/her capacity to identify same.

### TECHNICAL FIELD

The invention belongs to the field of language learning and language comprehension, particularly to the area of learning of phonology and phonetics.

### PRIOR ART

### References

The following references show the prior art and some general knowledge that will be used to explain this invention.

[1] Blevins, J. (1995): The Syllable in Phonological Theory, en [Goldsmith 1995]
[2] Borden, G. J., Harris, K. S., Raphael, L. J. (1994): “Speech Science Primer: Physiology, Acoustics and Perception of Speech”, Williams and Wilkins.
[3] Boysson-Bardies, B. (2001): “How Language Comes to Children”, The MIT Press, Cambridge.
[4] Ewen, C. J., van der Hulst, H. (2001): “The Phonological Structure of Words”, Cambridge: Cambridge University Press.
[5] Goldsmith, J. (1995): “The Handbook of Phonological Theory”, Cambridge Mass., Blackwell Publishers.
[6] Jackendoff, R. (2002): “Foundations of Language”, Oxford University Press, Oxford.
[7] Ladefoged, P. (2001): “Vowels and Consonants”, Malden, Mass.: Blackwell Publishers.
[8] Quilis, A., Fernández, J. (1975): “Curso de fonética y fonología españolas para estudiantes angloamericanos” (Course on Spanish phonetics and phonology for Anglo-American students), CSIC

Learning a foreign language is a process that is full of obstacles for the adult learner. Learners often reach situations in which the language that they learns ends up phosilizing, being in a status that is very far from the target language that they wanted to learn. Even though current science has some understanding about many processes of language learning, this area still remains a difficult area for everyone.

On the other hand, there also exist many people who have problems in using their native language. In some aspects, there exist some parallelisms between learning a foreign language and enhancing the command of the native language for a person who has language problems. The same techniques can be used for help individuals in both situations.

Explanation of the Invention

Analysis of the Problem

The present invention uses existing scientific knowledge about language learning in order to:

identify an area that creates important problems for the integral learning of language, and

propose a way to enhance the learning of that area.

Modern science has shown that learning phonology and phonetics is, beyond providing a good pronunciation, a key area for the integral learning of language. In language there exist different representation levels, and in each of them there exist rules that distinguish the correct forms from the incorrect forms. The different levels are mutually interdependent, with this interrelations being based on what Jackendoff calls interface rules [Jackendoff 2002, p. 125].

In these circumstances, a deficient learning of phonetics and phonology will difficult or delay the learning of other aspects of the language with which phonetics and phonology interrelate, such as for example syntax. The result of this is that learning phonetics and phonology gains importance beyond just a good accent, because they assist in the integral use of the language.

For example, the variations in frequency, intensity and duration of the sounds of an aural utterance, i.e. its prosody, show the structure of the utterance, i.e. the organization of the phrases and words that make it up. Despite one might think that the words in the aural discourse are separated by pauses, such as what happens in written language, this is not the case in reality. It is basically prosody that allows to discriminate words and groups of words.

An illustrative example of this case, taken from [Quilis et al 1975], is the following. The Spanish word groups “la vaca lentita” and “lava calentita” contain the same sounds: “lavacalentita”. However, if a normal native speaker produces orally both word groups, any normal native speaker would easily distinguish whether it is the first word group that is being uttered or it is the second one. This is due to the prosody that exists in the utterances, which indicates the different words.

Besides the importance that prosody has in order to signal the structure of the messages, it is also thought that the reason why the brain can process language so fast and reliably is due to the utilization of the prosodic information of the messages that are being processed. This prosodic information contains variations in duration, intonation and intensity, with the relative importance of each one being dependent on the particular language.

There is also evidence that prosody has a very important role for the child who is learning the native language. It has been shown, for example, that five month old children are able to detect the borders between subordinate clauses by interpreting the prosody of the language samples they are listening to. When they are nine months old, they have already acquired the ability to distinguish the borders between other inferior phrases to the subordinate clauses (such as noun phrases and so on) [Boysson-Bardies 2001, p. 103].

The conclusion is that prosody, i.e. the variations in frequency, intensity and duration of the sounds of language, has a facilitating effect for the general learning of language in children, and it is logical to assume that it can also facilitate the learning of language in other different contexts.

After realizing the importance that phonetics and phonology have, the issue is what to do in order to achieve that learning of these aspect progresses. In order to do that, it is necessary to check what phonetics and phonology are, and how the speaker processes them.

Two key aspects in phonology and phonetics are the syllable and the vocalic sounds. The perception of aural languages is organized around syllables [Boysson-Bardies (2001), p. 27]. The syllable is the basic rhythmic unit of natural languages. All languages are syllabic [Boysson-Bardies (2001), p. 45]. Each syllable is made up of one or more different sounds, which are called segments.

In all languages, syllables are made up of consonants and vowels [Boysson-Bardies (2001), p. 45], which constitute the constituents of the syllable. More precisely, the syllable is built with consonants and some sounds that have to satisfy certain sonority requirements. This requirement is that such sound must have more sonority than the segments that surround it in the syllable [Ewen et al (2001), p. 120]. There are three degrees of sonority: vocalic sounds, sonorous consonants, and obstructive consonants, of which vocalic sounds are the most sonorous [Ewen et al (2001), p. 10]. Technically, vocalic sounds and sonorous consonants have the feature “sonorous”, and it is also said that they are sonorous sounds [Ewen et al (2001), p. 10]. Sonorous sounds are sounds whose waveform is periodic, and are produced with a sustained vibration of the vocal cords. The sonorous sounds are the vocalic sounds (vowels, diphthongs, and pseudo vowels, such as “w” in English), the liquid consonants (“1” and “r”) and the nasal consonants (“m”, “n”). (In this document, and with the purpose of not adding too many details, letters will be used to represent sounds). In Spanish, syllables always have a vowel sound, but in other languages this is not the case. For example, in English, there exist syllables that are created around liquid sounds, such as the second syllable of the English word “little” [Jackendoff 2002, p. 8]. In general, the cases in which a syllable does not contain a vowel sound are very rare.

There exist different approaches to explain the internal structure of the syllable. In a particular approach, it is considered that it is composed by a nucleus, on which the sonority pick is located, and by transitions, which are usually composed by consonants [Jackendoff 2002, p. 8]. In Spanish, the nuclei are composed by vocalic sounds.

There also exist different theories about how the sounds of language get organized in order to create messages, but in general it is considered that the sounds are structured in several different levels, and that in each one of them there exists a certain rhythmic pattern [Ewen et al 2001, p. 202]. Regarding syllables, they are organized in a metric grid which is similar to the metric grids used in music, whose nodes are the nuclei of the syllables. Prosody lies on that metric grid. This way, vocalic sounds are the ones that support the main part of languages' prosody [Boysson-Bardies 2001, p. 43]. The speaker, upon receiving the messages, follows the rhythm marked by the relative variations of emphasis in the different syllables. This emphasis variations follow certain rules [Jackendoff 2002, p107-122], which have begun to be understood in the last twenty-five years, even though they are not completely clear yet.

Essence of the Invention

As a result of the previous analysis, the invention is based on facilitating that the learner perceives the rhythm and the metric grid of aural utterances. Acting this way, the learner will learn phonetics and phonology better and, as a result, will enhance the integral learning of the language in the following aspects:

detect more efficiently the different sounds that make up speech,

better distinguish the borders between words,

identify the syntactic structure of the speech samples that he/she receives,

remember the sounds of the target language better,

produce a speech that is closer to the target language.

The next issue is how to facilitate that the learner perceive the rhythm and the metric grid of the target language. In order to do that, the invention proposes to provide the learner with several aural reproductions, and to utilize some facilitating means in order to increase the learner's perceptive capacity and assimilation of the rhythm and of the metric grid of the target language.

The facilitating means which are used will depend on the particular embodiment of the invention. In what follows, and with the goal to facilitate the exposition, the most representative means are described. The remaining facilitating means are described in the section describing the preferred embodiment. It is understood that the following description is not limitative, and that the limits are imposed by the claims' text.

In general, in order to facilitate perceiving the rhythm and the metrical grid of the languages, some aural reproductions are used. These sound reproductions can be of two types: empty reproductions and full reproductions. EMPTY REPRODUCTIONS do not have lexical content, nor words, i.e. they are only sound sequences that reflect variations in tone, intensity and duration in a similar way to the prosodic patterns of the target languages. FULL REPRODUCIONS are real sound samples of the target languages, even though they might have some special characteristics, such as for example having been performed emphasizing syllables, emphasizing words, or with some other type of special characteristic.

There exist several ways to generate empty reproductions in order to make sure that their prosodic characteristics are similar to the prosodic characteristics of the target language. Some of this ways are mentioned in the following lines:
Filtering real sound reproductions of the target language in order to keep the prosodic information but to remove the phonetic load, or to leave a minimum load, as done in the experiments described in [Boysson-Bardies 2001, p. 22, 103].
Linking syllabic sounds, such as “la-la-la . . . ” or other type of syllables, in a similar way to how Ladefoged describes the relation between intonation and perception in [Ladefoged 2001, p. 18]. With this method, it is possible to build this sequence of syllables by the manipulation of a full reproduction, by replacing all the vocalic sounds by a single vowels. In this case, diphthongs, triphthongs and other groups of vocalic sounds that exist within the same syllable can be replaced by a number of vowels, instead of by a single one. For example, the Spanish word “hacia” can be replaced by “azaa”, where the “h” has been eliminated and “c” has been replaced by “z” in order to indicate the phonetic content of the word. Another possibility is to replace all combinations of vocalic sounds by a single vowel, and applying this possibility to the previous example would yield “aza”.
Concatenating periodic sounds, such as pure tones or other periodic sounds, such as vowels; with this method, it is possible to build a vowel sequence by using a full reproduction, in which consonants are removed and all vocalic sounds are left.
Concatenate other type of sounds

Except when stated otherwise, it will be understood that the empty reproductions that are mentioned in this document might have been created by any of the previous methods and with any of the previous characteristics.

In the next lines two different ways to use the invention will be described. It is understood that the invention is not limited to them, and these two ways to use the invention only have a descriptive purpose. The limitations on the invention will appear in the claims.

In this ways to use the invention, empty reproductions and full reproductions are used in an exercise that develops the learner's capacity to perceive the rhythm of speech. These exercise can be performed in two modes of utilization, as described below:
1. Utilization mode 1: In this mode of utilization, the following reproductions are used:
   An empty reproduction that has been obtained in some way and that has the same prosodic content as a real sample of the target language.
   Several samples of the target language, one of which has the same prosodic content as the previous empty reproduction.
      In this exercise, the empty reproduction is reproduced, and certain information about the previous samples of target language is provided to the learner, and the learner must choose the language sample that has the same prosodic content as the empty reproduction.
      The activity can be performed in two different ways, yielding two submodes of utilization:
   In submode 1, the information that is provided to the learner about the samples of target language are the same aural reproductions that correspond to the different language samples. This submode is more appropriate at the beginning of the instruction, in order to avoid creating associations between sounds and graphemes.
   In submode 2, the information that is provided to the learner about the samples of target language are the written transcripts that correspond to the different language samples. This submode is more appropriate for an intermediate stage in the instruction, and to develop the skills of reading and writing.
2. Utilization mode 2: In this mode of utilization, the following is used:
   a real sample of target language, called base sample
   several empty reproductions, which can correspond to a group of real language samples or might have been obtained by other way. One of these empty reproductions has the same prosodic content as the base sample.
      In the activity, the learner is provided with the previous empty reproductions, and he/she is also provided with certain information about the base sample. The learner has to choose the empty reproduction that has the same prosodic content as the base sample.
      The activity can be performed in two different ways, yielding two submodes of utilization:
   In submode 1, the information that is provided to the learner about the base sample is the aural reproduction of the base sample itself. This submode is more appropriate at the beginning of the instruction, to avoid creating associations between sounds and graphemes.
   In submode 2, the information that is provided to the learner about the base sample is the written transcript of the base sample itself. This submode is more appropriate for an intermediate stage of the instruction, and to develop the reading skills.

The invention aids the learner in developing the capacity to perceive the characteristic prosodic rhythm of the target language.

In general, in this document the terms “learner” or “user” will be used to refer to the person who is using the invention to enhance his/her command of a target language.

The invention can be used in training sessions or in informative sessions. In TRAINING sessions, a tutor has chosen and stored certain reproductions that are going to be used. In INFORMATIVE sessions, the user is working on a sample of target language on which he/she has a special interest.

The invention can be used in an isolated way or can be used simultaneously to other systems or methods orientated to the comprehension and/or learning of languages. For example, it can be used with a system that is orientated to the comprehension of target language samples in which the learner has an informative interest, such as form example could be documentaries, movies or other type of content.

Finally, the present invention can be used not only in foreign language learning, but also in order to help those individuals who have certain problems with the utilization of the native language which are related with phonetics or phonology. That is to say, the aspects that are covered basically belong to the language environment, regardless whether it is a foreign language or the native language.

Assessment of the Invention and Advantages of the Invention

The advantages that the invention provides are the following:
1. helping the learner to enhance his/her capacity to perceive and process the sounds of language, and therefore to enhance his/her capacity for listening comprehension,
2. helping the learner to enhance his/her prosody, so that he/she can generate oral utterances with better accent, thanks to a better intonation,
3. helping the learner to produce the sounds of the language with better quality and therefore with better accent, thanks to his/her enhanced perception of the sounds of language,
4. helping the language to enhance his/her perception of the syntactic structure of language by a better assimilation of the phonology, and therefore to enhance the general comprehension of the language, both in oral and written form
5. helping the learner to enhance his/her capacity to learn words in the normal utilization of language, in contrast to the learning generated by studying and consulting dictionaries.

### DESCRIPTION OF THE DRAWINGS

Exposition of an Embodiment of the Invention

### DESCRIPTION OF THE PREFERRED EMBODIMENT

The preferred embodiment of the invention uses a computerized system, based for example on a Dell® Dimension XPS®, adding a mouse and a keyboard so that the user interacts with the system. In the computerized system there exists an operating system that can be, for example, Microsoft® Windows 2000®.

A set of samples of language in textual form are stored in the computerized system. These samples might have been generated with the goal of facilitating learning, with the goal of satisfying an informative need of the speakers of the target language, or with a different goal.

The system comprises a module to convert text to speech, which will be used to produce aural reproductions of the target language samples that are stored in text form. That is to say, it is possible to get access in the system to the aural reproductions of the target language samples, which might have been generated with different characteristics, such as for example emphasizing the different syllables.

The system also comprises a phonetic filtering module to remove phonetic characteristics of the real reproductions, but respecting prosodic content, in a similar way as how it is done in the experiments described in [Boysson-Bardies 2001, p. 22, 103].

The system also comprises a module for digital high-pass filtering and amplification, created in a way that it filters signals in a similar way to the filtering produced by a resonator that is similar to the conduct of the external ear of a child.

The modules that have been mentioned and the functionality to manage user interactions can be developed with a development environment, such as for example Microsoft® Visual C++®.

For each of the samples of target language that have been generated for training sessions, there exist four native real reproductions that have been generated with the following characteristics:
1. a reproduction has been executed at normal speed and in a normal way,
2. a reproduction has been executed at low speed and in a normal way
3. a reproduction has been executed at low speed and emphasizing the syllables
4. a reproduction has been executed at low speed and emphasizing the words

These reproductions will be used as an assistance in some of the facilitating means that are used in the invention.

The language samples used for training sessions have been chosen with the usual criteria of language teachers and tutors. They will cover the main types of sentences that exist in the target language: declarative, interrogative, exclamative, imperative, passive, relative and others; also, the different sentences will cover multiples cases of subordinate clauses and coordinated clauses in different ways. This way, the learner will be exposed to a wide range of prosodic variations. The training sessions will be used to train certain types of sentences in a specific form; that is to say, in some cases groups of sentences sharing some common feature will be created that will be used in a serial way. For example, a group of sentences might be those declarative relative sentences of subject type, such as for example “That is the man who came yesterday”.

As was explained before, there exist different types of facilitating means. These types of facilitating means yield twelve modes of utilization of the invention, two of which were already explained before. The preferred embodiment comprises all twelve modes of utilization.

The twelve modes can be grouped in five blocks, as is explained below. All the modes can be used in training sessions, but only some of them are compatible with informative sessions. The different modes of utilization that are shown can be practiced independently from each other. However, they can also be combined, except for certain obvious exceptions, choosing types of each of the four groups. In some modes of utilization there exist more than one submode, depending on how certain alternatives are executed.

All the empty reproductions that are used in the preferred embodiment are built applying the system of phonetic filtering, which preserves the prosodic information.

Block A. Modes Associated to the Content of the Reproduction

1. Mode of utilization 1: This mode of utilization was explained before, in the explanation of the invention. For this mode of utilization, a set of language samples are chosen first, and their full reproductions are generated. Next, an empty reproduction is generated after one of the language samples.
2. Mode of utilization 2: This mode of utilization was also explained before, in the explanation of the invention. For this mode of utilization, a set of language samples are chosen first, and their empty reproductions are generated. Next, a full reproduction is generated for one of the samples of the target language.

3. Mode of utilization 3: The facilitating means used in this method are characterized by repeatedly listening to empty reproductions. This way, the learner will take direct contact with the existence of prosody, because since he/she is not being distracted by the content of the message, he/she will be able to better perceive the presence of the metric grid and the rhythms of tone, intensity and duration. After a number of training sessions, the learner will have enhanced his/her sensitivity to the prosody of the target language.

4. Mode of utilization 4: In this case, the facilitating means are characterized by utilizing full reproductions and intensifying the features of the prosody of language, by modifications of tone, intensity or duration of sounds. This intensification will facilitate that the learner perceives the role of prosody. Its utility is related to the fact that there is some agreement among the scientific community that the reproductions with exaggerated prosody by baby care takers are an important factor that helps children learn the language [Boysson-Bardies 2001, p. 83, 85, 86, 88]. This phenomenon must be effective also with learners of foreign languages.
5. Mode of utilization 5: The facilitating methods in this mode are characterized by using full reproductions and emphasizing certain fragments in them to assist the learner to identify all sounds. In this type of facilitating means, there are three submodes:
   in submode 1, the syllables are emphasized,
   in submode 2, the words are emphasized,
   in submode 3, certain phrases are be emphasized.
6. Mode of utilization 6: The facilitating means are characterized by utilizing full reproductions that contain a high proportion of sounds that have some common features, so that the systematic presence of similar sounds will facilitate perceiving the rhythm, in a similar way as how the metronome facilitates the musician the perception of rhythm.
   An example could be creating language samples that contain a high percentage of similar syllables, such as for example examples syllables of the type consonant-vowel (CV). This way, the natural rhythm of the reproduction would be reinforced by the periodic rhythm produced by the sequences “CVCVCVCV”. The utilization of syllables of the type CV would be especially positive, given that it is the only type of syllable that exists in all the languages of the word [Blevins 1995, p. 217]. It is considered that the syllables of the type CV belong to the non marked alternative of language, and are therefore easier to acquire. In cognitive science and linguistics, “non marked” means that when the child is learning the native language, somehow he/she already knows that there exist syllables of the type “CV”. However, if his/her language comprises other type of syllables, such as for example “CVC”, he/she will have to learn it specifically. The consonants or the vowels would preferably share as many features as possible, for example the labial feature (which corresponds to the sounds of the letters “p”, “b” and “m” in Spanish)
   For this utilization mode, it will be necessary to choose special language samples for the training sessions; they must contain a high proportion of those chosen syllables. The second step would be generating real reproductions.
      Block B. Means about the Processing of the Reproduction
7. Mode of utilization 7: The facilitating means in this case are characterized by utilizing full reproductions that have been filtered, so that the frequencies beyond a certain value are amplified, around 2000 Hz. The intensification of the high frequencies is important for speech perception, because much of the energy of the sound that distinguishes fricative sounds among themselves is located in frequencies above 2000 Hz. Actually, it is considered that the natural filtering that the conduct of the external ear of the ear performs, due to its lower length, contributes to facilitate language perception [Borden et al 1994, p. 177].
   In the preferred embodiment, in order to build this mode of utilization, any real reproduction would be chosen, and the it would be applied the high pass filtering module.
      Block C. Means Associated to the Activity of the Learner
8. Mode of utilization 8: The facilitating mans are related characterized because there exists a written transcript of the aural reproductions of the real language samples that the learner is listening to, so that he/she reads the transcript as he/she is listening to the reproductions. Because the learner usually will understand the written text better than he/she will understand the aural reproduction, as he/she performs this activity he/she will be associating the meaning of the language sample with the sounds and prosody of the reproduction. The written transcript will help the learner to understand the meaning of the language sample.
   For this mode of utilization, a real reproduction is generated after the text that has been chosen, and then it is only necessary to show the text on the screen of the computerized system, in parallel to the aural reproduction. In order to facilitate the utilization, the system might have some functionality that will allow to graphically emphasize the text fragments that are reproduced at every moment, for example by using a different font format or using some other graphical mean.
      Block D. Means about the Attitude of the Learner
9. Mode of utilization 9: In this mode of utilization, the facilitating means are characterized by giving instructions to the learner for him/her to put special attention to the rhythm of certain units of language, while he/she is listening to the real aural reproductions of the target language. In this mode of utilization, there might exist up to five different submodes:
   In submode 1, the instructions request to pay attention to the vowels.
   In submode 2, the instructions request to pay attention to the vocalic sounds in general. Probably, this is the most important mode of utilization, because vocalic sounds provide a large part of the language information and prosody.
   In submode 3, the instructions request to pay attention to the sonorous sounds.
   In submode 4, the instructions request to pay attention to the consonants.
   In submode 5, the instructions request to pay attention to the syllables.
   The benefits of this mode of utilization are that, given that the rhythm and metric structure of language are supported on the syllable, the learner will be able to much better perceive both of them. This way, he/she will also enhance his/her perception of the different sounds and of the syntactic structure of the messages that he/she receives.
   In order to center the attention on the syllables, the learner can focus on the syllable itself, which yields submode 5, or on other parts internal to the syllable, which yields the other submodes of utilization.
   Even though there can exist five submodes, the preferred embodiment only covers submodes 2, 4 and 5. Submodes 1 and 3 have been explained with the purpose of facilitating the comprehension of the invention. They are not included in the preferred invention because of the following reasons. The submodes associated to vowels are not included because they are already subsumed within the vocalic sounds, and these are sufficiently clear. The submodes associated to sonorous sounds are not included because they are not easily to understand intuitively, given that they are consonants, and because in general there are few syllables that get build around non vocalic sounds.
   In order to explain what is understood by each type of sounds, for each submode, in the preferred embodiment some training reproductions are generated to help the learner perceive the essence of the activity.
   For submode 2, the instructions request the learner to pay attention to the rhythm of vocalic sounds in general. The training reproductions would be empty reproductions that have been created with sequences of vowels, diphthongs and other vocalic sounds.
   For submode 4, the instructions request the learner to pay attention to the rhythm of the consonants. The training reproductions would be empty reproductions that are built with syllable sequences in which the consonant changes but the vowel remains.
   For submode 5, the instructions request the learner to pay attention to the rhythm of the syllables. The training reproductions would be full reproductions that have been generated emphasizing the syllables.
10. Mode of utilization 10: The facilitating means are characterized by providing instructions to the learner to pay special attention to the rhythm of words that appear while the learner is listening the real aural reproductions of the target language.
   For this mode of utilization, it is only necessary to communicate the learner the appropriate instructions when he/she is going to listen to the reproduction, indicating him/her to pay attention to rhythm of appearance of words.
11. Mode of utilization 11: The facilitating means are characterized by providing instructions to the learner to pay special attention to the evolution of the prosody of the real aural reproductions of the target language while he/she is listening to those reproductions, so that he/she tries to perceive groups of words that have some relation (i.e. phrases). In a particular case, it will be requested to the learner to try to perceive groups of words that indicate events or states (i.e. phrases that correspond to subordinate clauses)

For this mode of utilization, it is only necessary to communicate the appropriate instructions to the learner when he/she is going to listen to the reproduction, indicating him/her to pay attention to the groups of words that have some relationship among themselves.

Block E. Means about the Rhythmicity of the Reproduction

12. Mode of utilization 12: The facilitating means are characterized by using full reproductions which have the form of poems or songs, so that due to the rhythmic nature of poems and songs it is easier to perceive the linguistic metric grid of the language samples that are included in those poems or songs. For this mode of utilization to be optimal, the full reproductions should have some special rhythmical characteristics, so that the linguistic metric grid is as aligned as possible with the metric grid that is characteristic of the medium that is being used, either poems or songs. This way, the own rhythm of poems or songs will contribute to make the linguistic rhythm more salient.
   In this mode of utilization there are two submodes:
   In submode 1, the full reproductions are poems. In order to align the metric grid of the poem with the linguistic metric grid, the optimal way for producing the reproductions would to use metrical feet with a fixed number of syllables, and preferably there would be two syllables per metrical feet, i.e. iambic or trochaic feet [Ewen et al (2001), p. 203].
   In submode 2, the full reproductions are songs, or fragments of songs. In order to align the metric grid of the song with the linguistic metric grid, the optimal way for producing the reproductions would try to comply with the following two circumstances in as much as possible: first, the musical structure would be such that all the notes would have the same duration; second, there would exist a high percentage of cases in which each musical note corresponds to a syllable (i.e. a node of the syllabic linguistic metrical grid) and only that musical note would correspond to that syllable.
      For this utilization mode, it is only necessary to find songs or poems that have the characteristics that have been mentioned.

In the modes of utilization of Block D, the attitude of the learner is optimal when he/she is not trying to identify words nor ‘identify’ or ‘generate’ the meaning of what he/she is listening to, but he/she is simply following the rhythm in a relaxed way, and allows his/her brain to spontaneously perform those functions. In these modes, it is necessary to give instructions to the user as to how he/she must listen to the reproductions. This will not be easy, because it is difficult to explain to a person what perceptions he/she must have. The three ideas that are considered to be more important to explain this issue to the learners are that he/she must be relaxed, that he/she should not put effort into building the meaning of words and sounds that he/she is listening to, and that he/she must follow the rhythm of the parts of the sound that correspond to the submode that he/she is using. This attitude is also appropriate for the other modes of utilization of the invention, or in the normal use of language, but it has been focused on a particular mode of utilization with the purpose of clarifying the exposition.

Among the modes and submodes explained, the most important ones are the submodes 1, 2 and 3 of mode 9, because they are the ones that make more salient the nodes of the syllabic metric grid, upon which prosody and language comprehension rest. Within these submodes, the most important one would be submode 2, because even though it excludes certain sounds that might be nuclei of syllables (i.e. the sonorous consonants) it is the easiest one to explain to the language learner, and because there exist few syllables whose nucleus is a sonorous consonant. Submode 1 would also be appropriate to provide instructions to the learner, but it can generate certain confusion if the learner starts thinking about the role of diphthongs and other vocalic sounds.

In the application of submodes 1, 2 and 3 of mode 9, it is not expected that the learner can perfectly and immediately comprehend the meaning of the messages that he/she perceives, but it will take some amount of training that will depend on the person, so that the listening comprehension skills will gradually evolve. The same reasoning can be applied in general to the other modes and submodes of utilization.

Within block D, modes 10 and 11 have less importance. In these modes, the learner pays attention to the rhythms generated by words and phrases, which result from the basic rhythm of syllables, which has already been covered in mode 9. Because of this, these modes would be used less than mode 9.

As was mentioned before, there exist some modes of utilization that cannot be combined. One of the obvious cases is the combination of the listening of pure prosodic sounds described in mode 1 with the reading of the written transcript.

The modes of Block D, in particular, can be used either with the reproductions generated for the modes 1-6, with those generated for the mode 7, or with other aural reproductions of the target language that the learner might be exploring or perceiving. That is to say, they are useful not only for training, but also for the utilization of language in real situations.

Mode of utilization 6 would be preferably used after the intermediate learning stages. The reason is that if it is used in the initial stages, it can create associations between the written form and the aural form that might negatively influence the learner.

### DESCRIPTION OF OTHER ALTERNATIVE EMBODIMENTS

It is possible to build alternative embodiments by using a lower number of modes or submodes of utilization. That is to say, it is possible to only use, for example, mode 1, or mode 2, or submode 2 of mode 9, or it is possible to use a combination of several modes and/or submodes.

In the simplest embodiment, for example, only the mode 9 and submode 2 would be used, because it is the most important one. In order to implement this mode, it would only be required to provide instructions to the learner to pay attention, for example, on vocalic sounds, and the real reproductions could be those produced, for example, for television or for radio or for any other communication means.

In other possible alternative embodiment in which mode of utilization 9 is also included, the learner is indicated to also pay attention to the sonorous sounds. This alternative would not be very useful, because the sonorous sounds that are not vocalic sounds are very rare, and it is difficult to explain their nature in an intuitive way.

In other possible alternative embodiment a new submode of utilization is created for the mode of utilization 2. In this submode, the information that is presented to the learner about the candidate language samples are characterized because for some samples the aural reproduction is provided, and for other samples the written transcript is provided.

In other alternative embodiment, the computerized system has different characteristics from the ones explained for the preferred embodiment.

Other alternative embodiment does not use a computerized system, but an audio system such as a magnetic tape recorder or a television set. In this case, there would exist a plurality of recorded reproductions and certain instructions that might be reproduced in the audio system. For example, for mode 1, a voice in the reproduction might indicate the learner to listen to certain real reproductions that will be reproduced next.

Other alternative embodiment uses, in addition to an audio system, a paper support. In order to utilize this embodiment with mode 8, the paper would contain the written transcript of the language sample that is reproduced in the audio system.

In another possible alternative embodiment, the reproductions might contain only some aspects of the prosody, ignoring others. For example, they could contain only variations of tone and intensity, and ignore the variation in duration of sounds. The embodiments that would follow this approach would be considered inferior ones, but would fall within the scope of the invention.

In another alternative embodiment, some empty reproductions are used that do not have the prosodic characteristics of the target language or that might not even have the prosodic characteristics of any language.

Other embodiments that would be considered to fall within the scope of the invention are those that might be developed for cases in which prosody is not based on variations of intensity, frequency and duration of sounds, but only on one or two of these magnitudes, as might happen in some languages or in some particular samples of language. In general, it is considered that prosody reflects all the phonological features that are related to language rhythm, and even though a particular embodiment uses only some of them, it is considered to be within the scope of the invention.

1. A method for facilitating language learning which is performed over a target language that can be a foreign language or the native language of the learner, wherein said method is characterized by the user listening to certain aural reproductions utilizing certain facilitating means, wherein
a. said facilitating means facilitate that the user perceive the sonorous features of the target language, i.e. those features that are related to the pronunciation, the intonation, the rhythm, the metrical structure, and/or the prosody of the target language; said facilitating means facilitate that the user develops the capacity to perform said perception; or said facilitating means facilitate to achieve both goals,
b. said aural reproductions might have been generated with real utterances produced by speakers or by speech technology systems, and said aural reproductions can be full reproductions or empty reproductions, wherein
full reproductions correspond to real samples of the target language,
empty reproductions are not real samples of target language, but they contain sequences of sounds that reproduce the prosodic patterns of the target language by variations in tone, intensity or duration,
wherein said method can be used in isolated fashion or as a complement in an approach whose goal might be to facilitate language learning, to present samples of a foreign language, or to correct some problem in the utilization of a native language.

2. A method as claimed in claim 1, wherein said empty reproductions might have been created by a plurality of ways, such as for example one of the following:
filtering full reproductions of the target language, so that the phonetic information of such full reproductions is eliminated or greatly reduced, while at the same time the prosodic information of said full reproductions is maintained,
linking syllable sounds, such as for example “la-la-la . . . ” or other syllables that might be equal or different to each other,
after full reproductions, in such as way that all the vocalic sounds are replaced by the same vowel, so that the empty reproductions have a similar prosody to the prosody that those full reproductions have,
linking sounds whose wave form is periodic, such as for example pure tones or vocalic sounds,
after full reproductions, by removing consonants so that only vocalic sounds remain, and the resulting reproductions have a similar prosody to the prosody that said full reproductions have,
in any other way

3. A method as claimed in claim 1, which is performed by performing one or more exercises, wherein for at least one of said exercises there exists one or more empty reproductions and one or more real samples of the target language, so that for at least one of said empty reproductions there is at least one real sample, among said real samples of the target language, that has an equivalent prosodic content, wherein said method comprises the steps of:
presenting the learner with characterizing information about one or more of said real samples of the target language,
presenting the learner with characterizing information about one or more of said empty reproductions,
associating, by the learner, of the empty reproductions with the real samples of the target language that have a similar prosodic content as they have.

4. A method as claimed in claim 3, wherein said characterizing information that is presented to the user about said real samples of target languages are the sonorous reproductions of said real samples of language, i.e., they are full reproductions.

5. A method as claimed in claim 3, wherein said characterizing information that is presented to the user about said real samples of target language are the written transcripts of said real language samples.

6. A method as claimed in claim 3, wherein there exists one single empty reproduction, and the learner must indicate the real sample or real samples of target language that correspond to said empty reproduction.

7. A method as claimed in claim 3, wherein there exists one single real sample of target language, and the learner must indicate the empty reproduction or reproductions that correspond to said real sample of target language.

8-13. (canceled)

14. A method as claimed in claim 1 wherein said aural reproductions are full reproductions and wherein said facilitating means are based on providing the user with instructions to listen those full reproductions in a special way.

15. A method as claimed in claim 14 wherein said special way is based on providing the user with instructions to pay attention to perceive the evolution of one of the following features:
the rhythm of certain parts of said full re productions,
the vocalic sounds, i.e., vowels, semivowels and diphthongs,
the vowels,
the consonants,
the syllables or a part of them such as their nucleus,
the words, which would yield the user to follow the rhythm of appearance of words,
groups of words that because of the prosody of the reproduction seem to have some relationship among themselves.

16-18. (canceled)

19. A system for facilitating language learning which is performed over a target language that can be a foreign language or the native language of the learner, wherein said system comprises the following means:
a. means to create certain aural reproductions that the user will listen to,
b. facilitating means that facilitate that the user perceive the sonorous characteristics of the target language, i.e., characteristics that are related to the related to the pronunciation, the intonation, the rhythm, the metrical structure, and/or the prosody of the target language;
that facilitate that the user develops the capacity to perform said perception; or that facilitate to achieve both goals,
wherein said aural reproductions might have been generated with real utterances produced by speakers or by speech technology systems, and said aural reproductions can be full reproductions or empty reproductions, wherein
full reproductions correspond to real samples of the target language,
empty reproductions are not real samples of target language, but they contain sequences of sounds that reproduce the prosodic patterns of the target language by variations in tone, intensity or duration,
wherein said method can be used in isolated fashion or as a complement in an approach whose goal might be to facilitate language learning, to present samples of a foreign language, or to correct some problem in the utilization of a native language.

20. A system as claimed in claim 19, wherein said empty reproductions might have been created by a plurality of ways, such as for example one of the following:
filtering full reproductions of the target language, so that the phonetic information of such full reproductions is eliminated or greatly reduced, while at the same time the prosodic information of said full reproductions is maintained,
linking syllable sounds, such as for example “la-la-la . . . ” or other syllables that might be equal or different to each other,
after full reproductions, in such as way that all the vocalic sounds are replaced by the same vowel, so that the empty reproductions have a similar prosody to the prosody that those full reproductions have,
linking sounds whose wave form is periodic, such as for example pure tones or vocalic sounds,
after full reproductions, by removing consonants so that only vocalic sounds remain, and the resulting reproductions have a similar prosody to the prosody that said full reproductions have,
in any other way

21. A system as claimed in claim 19, further comprising means to execute one or more exercises, wherein for at least one of said exercises there exist one or more empty reproductions and one or more real samples of the target language, so that for at least one of said empty reproductions there is at least one real sample, among said real samples of the target language, that has an equivalent prosodic content, wherein said exercise comprises the steps of:
presenting the learner with characterizing information about one or more of said real samples of the target language,
presenting the learner with characterizing information about one or more of said empty reproductions,
associating, by the learner, of the empty reproductions with the real samples of the target language that have a similar prosodic content as they have.

22. A system as claimed in claim 21, wherein said characterizing information that is presented to the user about said real samples of target languages are the sonorous reproductions of said real samples of language, i.e., they are full reproductions.

23. A system as claimed in claim 21, wherein said characterizing information that is presented to the user about said real samples of target language are the written transcripts of said real language samples.

24. A system as claimed in claim 21, wherein there exists one single empty reproduction, and the learner must indicate the real sample or real samples of target language that correspond to said empty reproduction.

25. A system as claimed in claim 21, wherein there exists one single real sample of target language, and the learner must indicate the empty reproduction or reproductions that correspond to said real sample of target language.

26-42. (canceled)

26. A computer readable medium containing computer executable instructions that, when executed by one or more processors of a computer, allow said one of more processors to execute the following steps:
managing one or more empty reproductions and one or more real samples of a target language, so that for at least one of said empty reproductions there is at least one real sample, among said real samples of the target language, that has an equivalent prosodic content
presenting the learner with characterizing information about one or more of said real samples of the target language,
presenting the learner with characterizing information about one or more of said empty reproductions,
receiving the association performed by the learner of the empty reproductions with the real samples of the target language that have a similar prosodic content as they have.

27. A computer readable medium containing a data set that, when interpreted by one or more processors of a computer, allows said one of more processors to perform the following steps:
presenting the learner with characterizing information about one or more of said real samples of the target language,
presenting the learner with characterizing information about one or more of said empty reproductions
